(19) United States
(12) Patent Application Publication
(10) Pub. No.: US 2026/0106138 A1
(43) Pub. Date: Apr. 16, 2026

(54) NEGATIVE ELECTRODE FOR RECHARGEABLE LITHIUM BATTERY AND RECHARGEABLE LITHIUM BATTERY INCLUDING THE SAME

(71) Applicant: Samsung SDI Co., Ltd., Yongin-si (KR)

(72) Inventors: Jinhee IM, Yongin-si (KR); Eunjoo LEE, Yongin-si (KR)

(21) Appl. No.: 19/239,807

(22) Filed: Jun. 16, 2025

(30) Foreign Application Priority Data
Oct. 11, 2024 (KR) 10-2024-0138773

(51) Int. Cl. H01M 4/36; H01M 4/02; H01M 4/133; H01M 4/134; H01M 4/38; H01M 4/583; H01M 4/62; H01M 4/66; H01M 10/0525

(52) U.S. Cl. CPC H01M 4/366; H01M 4/133; H01M 4/134; H01M 4/386; H01M 4/583; H01M 4/622; H01M 4/625; H01M 4/661; H01M 10/0525; H01M 2004/021; H01M 2004/027

(57) ABSTRACT

A negative electrode for a rechargeable lithium battery and a rechargeable lithium battery including the same are provided. A negative electrode for a rechargeable lithium battery includes a negative electrode current collector and a negative electrode active material layer on the negative electrode current collector, wherein the negative electrode active material layer includes a negative electrode active material. The negative electrode active material includes a first negative electrode active material including a matrix containing a first crystalline carbon and silicon dispersed in the matrix, and a second negative electrode active material including a second crystalline carbon. The second negative electrode active material has a graphitization degree of about 88% to about 94%.

### CROSS-REFERENCE TO RELATED APPLICATION

The present application claims priority to and the benefit of Korean Patent Application No. 10-2024-0138773, filed on Oct. 11, 2024, in the Korean Intellectual Property Office, the entire content of which is incorporated herein by reference.

### BACKGROUND

### A. Field

Embodiments of the present disclosure relate to a negative electrode for a rechargeable lithium battery and a rechargeable lithium battery including the same.

### B. Description of the Related Art

Recently, the rapid spread of battery-powered electronics, such as mobile phones, laptop computers, and/or electric vehicles, has driven a sharp rise in the market for rechargeable batteries having high energy densities and high capacities. Accordingly, extensive research efforts are directed towards improving the performance of rechargeable batteries (such as rechargeable lithium batteries), for example, in terms of energy density, cycle life, and/or safety.

Rechargeable lithium batteries may include a positive electrode and a negative electrode, each including an active material that allows intercalation and deintercalation of lithium ions, and an electrolyte solution. The batteries produce electrical energy from redox reactions that take place as lithium ions are intercalated into or deintercalated from the positive electrode and the negative electrode.

The above information disclosed in this Background section is intended to enhance understanding of the background of the disclosure and may contain information that does not constitute prior art.

### SUMMARY

Aspects of one or more embodiments of the present disclosure are directed toward a negative electrode for a rechargeable lithium battery with enhanced (e.g., improved) capacity and electrode plate processability.

Aspects of one or more embodiments of the present disclosure are directed to a negative electrode for a rechargeable lithium battery including first and second negative electrode active materials described herein that provide rechargeable batteries having high capacities and high energy densities along with enhanced (e.g., excellent or suitable) life and rate characteristics.

Aspects of one or more embodiments of the present disclosure are directed to a negative electrode for a rechargeable lithium battery exhibiting excellent or suitable cycle life characteristics and high input/output characteristics.

Aspects of one or more embodiments of the present disclosure are directed to a rechargeable lithium battery including the negative electrode.

Additional aspects will be set forth in part in the description which follows and, in part, will be apparent from the description, or may be learned by practice of the presented embodiments of the disclosure.

One or more embodiments of the present disclosure provide a negative electrode for a rechargeable lithium battery, including a negative electrode current collector and a negative electrode active material layer on the negative electrode current collector, wherein the negative electrode active material layer includes a negative electrode active material. The negative electrode active material includes a first negative electrode active material including a matrix containing a first crystalline carbon and silicon dispersed in the matrix, and a second negative electrode active material including a second crystalline carbon. The second negative electrode active material has a graphitization degree of about 88% to about 94%.

In one or more embodiments of the present disclosure, a negative electrode for a rechargeable lithium battery includes a negative electrode current collector and a negative electrode active material layer on the negative electrode current collector, wherein the negative electrode active material layer includes a negative electrode active material. The negative electrode active material includes a first negative electrode active material including a matrix containing a first crystalline carbon and silicon dispersed in the matrix, and a second negative electrode active material including a second crystalline carbon. The first negative electrode active material and the second negative electrode active material are provided in a weight ratio in a range of about 10:90 to about 50:50.

In one or more embodiments of the present disclosure, a rechargeable lithium battery includes the negative electrode described above, a positive electrode, and a separator between the negative electrode and the positive electrode.

### BRIEF DESCRIPTION OF THE DRAWINGS

The accompanying drawings are included to provide a further understanding of the present disclosure, and are incorporated in and constitute a part of this specification. The drawings illustrate embodiments of the present disclosure and, together with the description, serve to explain principles of the present disclosure. In the drawings:

FIG. 1 is a simplified conceptual view showing a rechargeable lithium battery according to one or more embodiments of the present disclosure;

FIGS. 2-5 are schematic views each showing a rechargeable lithium battery according to one or more embodiments of the present disclosure, where FIG. 2 shows a cylindrical battery, FIG. 3 shows a prismatic battery, and FIGS. 4 and 5 show pouch-type (kind) batteries, according to embodiments of the present disclosure;

FIG. 6 is a cross-sectional view showing an electrode assembly of a rechargeable lithium battery according to one or more embodiments of the present disclosure;

FIG. 7 is a cross-sectional view showing a negative electrode for a rechargeable lithium battery according to one or more embodiments of the present disclosure; and

FIG. 8 is a view schematically showing a first negative electrode active material according to one or more embodiments of the present disclosure.

### DETAILED DESCRIPTION

The present disclosure may be modified in many alternate forms, and thus specific embodiments will be illustrated in the drawings and described in more detail. It should be understood, however, that this is not intended to limit the present disclosure to the particular forms disclosed, but rather, is intended to cover all modifications, equivalents, and alternatives falling within the spirit and scope of the present disclosure.

Hereinafter, example embodiments will be described in more detail with reference to the accompanying drawings. The present disclosure, however, may be embodied in various different forms, and should not be construed as being limited to only the illustrated embodiments herein. Rather, these embodiments are provided as examples so that this disclosure will be thorough and complete, and will fully convey the aspects and features of the present disclosure to those skilled in the art. Accordingly, processes, elements, and techniques that are not necessary to those having ordinary skill in the art for a complete understanding of the aspects and features of the present disclosure may not be described.

It will be understood that when an element, such as an area, layer, film, region or portion, is referred to as being “on” another element, it can be directly on the other element, or one or more intervening elements may be present. In contrast, when an element or layer is referred to as being “directly on” or “immediately adjacent to” another element or layer, there are no intervening elements or layers present. In addition, it will also be understood that when an element is referred to as being “between” two elements, it can be the only element between the two elements, or one or more intervening elements may also be present.

Unless otherwise noted, like reference numerals denote like elements throughout the attached drawings and the written description, and thus, duplicative descriptions thereof may not be provided. In the drawings, the relative sizes (e.g., including lengths, widths and thicknesses) of elements, layers, and regions may be exaggerated for clarity.

As used herein, the singular forms “a,” “an” and “the” are intended to include the plural forms as well, unless the context clearly indicates otherwise. In addition, unless otherwise specified, the phrase “A or B” may indicate “A but not B”, “B but not A”, or “A and B”.

It will be further understood that the terms “comprises,” “comprising,” “includes,” “including,” “have,” “having,” “contain,” and “containing,” when used in this specification, specify the presence of the stated features, integers, steps, operations, elements, and/or components, but do not preclude the presence or addition of one or more other features, integers, steps, operations, elements, components, and/or groups thereof. Additionally, the terms “comprise(s)/comprising,” “include(s)/including,” “have/has/having,” “contains/containing,” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

As used herein, the term “combination thereof” may refer to a mixture, a stack, a composite, a copolymer, an alloy, a blend, or a reaction product.

In the present disclosure, when particles are spherical, “diameter” or “size” indicate a particle diameter or an average particle diameter, and when the particles are non-spherical, the “diameter” or “size” indicate a major axis length or an average major axis length. Unless otherwise defined herein, a particle diameter (size) may be an average particle diameter. In addition, a particle diameter (size) is defined as an average particle diameter (D50) indicating the diameter of particles at a cumulative volume of about 50 vol % in particle size distribution, and refers to the value of the particle size corresponding to 50% from the smallest particle when the total number of particles is 100% in the distribution curve accumulated in the order of the smallest particle size to the largest particle size. The average particle diameter (D50) may be measured by a method widely available to and/or utilized by those skilled in the art, for example, by a particle size analyzer, an image of transmission electron microscope (TEM), or an image of scanning electron microscope (SEM). Alternatively, the average particle diameter (D50) may be measured by a measurement device using dynamic light-scattering, wherein data analysis is conducted to count the number of particles for each particle size range, and an average particle diameter (D50) value may then be obtained through calculation. Also, a laser scattering method may be utilized to measure the average particle diameter. In measuring using the laser diffraction method, target particles are dispersed in a dispersion medium, introduced into a commercially available laser diffraction particle diameter measuring device (e.g., MT 3000 available from Microtrac, Ltd.), irradiated with ultrasonic waves of about 28 kHz at a power of 60 W, and then an average particle diameter (D50) based on 50% of the particle diameter distribution in the measuring device may be calculated.

As used herein, the term “and/or” includes any and all combinations of one or more of the associated listed items. Unless otherwise apparent from the disclosure, expressions such as “at least one of,” “a plurality of,” “one of,” and other prepositional phrases, when preceding a list of elements, should be understood as including the disjunctive if written as a conjunctive list and vice versa. For example, the expressions “at least one of a, b, or c,” “at least one of a, b, and/or c,” “one selected from the group consisting of a, b, and c,” “at least one selected from among a, b, and c,” “at least one from among a, b, and c,” “one from among a, b, and c”, “at least one of a to c” indicates only a, only b, only c, both a and b, both a and c, both b and c, all of a, b, and c, or variations thereof.

As used herein, the terms “use,” “using,” and “used” may be considered synonymous with the terms “utilize,” “utilizing,” and “utilized,” respectively.

It will be understood that, although the terms “first,” “second,” “third,” etc., may be used herein to describe various elements, components, regions, layers and/or sections, these elements, components, regions, layers and/or sections should not be limited by these terms. These terms are used to distinguish one element, component, region, layer or section from another element, component, region, layer or section. Thus, a first element, component, region, layer or section described below could be termed a second element, component, region, layer or section, without departing from the spirit and scope of the present disclosure.

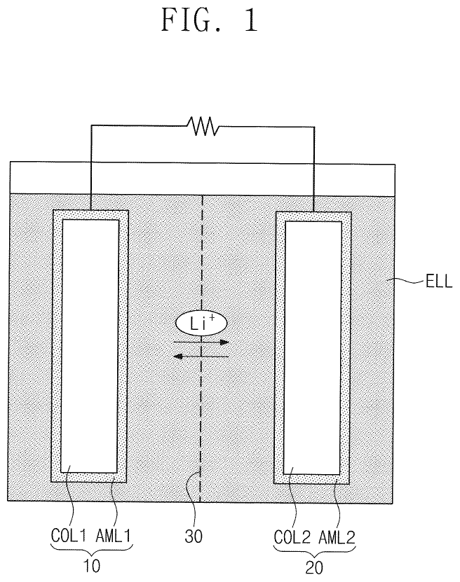

FIG. 1 is a simplified conceptual view showing a rechargeable lithium battery according to one or more embodiments of the present disclosure. Referring to FIG. 1, the rechargeable lithium battery may include a positive electrode 10, a negative electrode 20, a separator 30, and an electrolyte solution ELL.

The positive electrode 10 and the negative electrode 20 may be spaced and/or apart (e.g., spaced apart or separated) from each other by the separator 30. The separator 30 may be arranged between the positive electrode 10 and the negative electrode 20. The positive electrode 10, the negative electrode 20 and the separator 30 may be in contact with the electrolyte solution ELL. The positive electrode 10, the negative electrode 20 and the separator 30 may be impregnated in the electrolyte solution ELL.

The electrolyte solution ELL may be a medium for transferring lithium ions between the positive electrode 10 and the negative electrode 20. In the electrolyte solution ELL, the lithium ions may move through the separator 30 toward the positive electrode 10 or the negative electrode 20.

### Positive Electrode 10

The positive electrode 10 for a rechargeable lithium battery may include a current collector COL1 and a positive electrode active material layer AML1 on the current collector COL1. The positive electrode active material layer AML1 may include a positive electrode active material and may further include a binder and/or a conductive material.

For example, the positive electrode 10 may further include an additive capable of serving as a sacrificial positive electrode.

The positive electrode active material layer AML1 may contain about 90 wt % to about 99.5 wt % of the positive electrode active material with respect to 100 wt % of the positive electrode active material layer AML1. With respect to 100 wt % of the positive electrode active material layer AML1, the binder and the conductive material may each be in an amount in a range of about 0.5 wt % to about 5 wt %.

The binder may serve to attach (e.g., effectively attach) positive electrode active material particles to one another and also to attach (e.g., effectively attach) the positive electrode active material to the current collector COL1. Examples of the binder may be polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and/or nylon, but the present disclosure is not limited thereto.

The conductive material may be used to impart conductivity to the electrode (e.g., may be a conductor). Any material that does not cause chemical changes and is an electron conductive material may be usable in batteries. Examples of the conductive material may include a carbon-based material such as natural graphite, artificial graphite, carbon black, acetylene black, ketjen black, carbon fiber, carbon nanofibers, and carbon nanotubes; a metal-based material including copper, nickel, aluminum, silver, and/or the like in a form of a metal powder or metal fibers; a conductive polymer such as a polyphenylene derivative; and/or a (e.g., any suitable) mixture thereof.

Aluminum (Al) may be used as the current collector COL1, but the present disclosure is not limited thereto.

### Positive Electrode Active Material

A compound capable of reversibly intercalating and deintercalating lithium (lithiated intercalation compound) may be used as a positive electrode active material in a positive electrode active material layer AML1. For example, at least one of a composite oxide of lithium and a metal selected from among cobalt, manganese, nickel, and/or a (e.g., any suitable) combination thereof may be used.

The composite oxide may be a lithium transition metal composite oxide, and examples thereof include lithium nickel-based oxide, lithium cobalt-based oxide, lithium manganese-based oxide, lithium iron phosphate-based compound, cobalt-free nickel-manganese-based oxide, and/or a (e.g., any suitable) combination thereof.

For example, a compound represented by any one or more of (e.g., selected from among) the following Formulas may be used: LiₐA_{1-b}X_{b}O_{2-c}D_{c} (0.90≤a≤1.8, 0≤b≤0.5, 0≤c≤0.05); LiₐMn_{2-b}X_{b}O_{4-c}D_{c} (0.90≤a≤1.8, 0≤b≤0.5, 0≤c≤0.05); LiₐNi_{1-b-c}Co_{b}X_{c}O_{2-α}D_{α} (0.90≤a≤1.8, 0≤b≤0.5, 0≤c≤0.5, 0<α<2); LiₐNi_{1-b-c}Mn_{b}X_{c}O_{2-α}D_{α} (0.90≤a≤1.8, 0≤b≤0.5, 0≤c≤0.5, 0<<<2); LiₐNi_{b}Co_{c}LiₐGₑO₂ (0.90≤a≤1.8, 0≤b≤0.9, 0≤c≤0.5,0≤d≤0.5, 0≤e≤0.1); LiₐNiG_{b}O₂ (0.90≤a≤1.8, 0.001≤b≤0.1); LiₐCoG_{b}O₂ (0.90≤a≤1.8, 0.001≤b≤0.1); LiₐMn_{1-b}G_{b}O₂ (0.90≤a≤1.8, 0.001≤b≤0.1); LiₐMn₂G_{b}O₄ (0.90≤a≤1.8, 0.001≤b≤0.1); LiₐMn_{1-g}G_{g}PO₄ (0.90≤a≤1.8, 0 sg≤0.5); Li_{(3-f)}Fe₂(PO₄)₃ (O≤≤2); and/or LiₐFePO₄ (0.90≤a≤1.8).

In the Formulas above, A is Ni, Co, Mn, and/or a (e.g., any suitable) combination thereof, X is Al, Ni, Co, Mn, Cr, Fe, Mg, Sr, V, a rare earth element, and/or a (e.g., any suitable) combination thereof, D is O, F, S, P, and/or a (e.g., any suitable) combination thereof, G is Al, Cr, Mn, Fe, Mg, La, Ce, Sr, V, and/or a (e.g., any suitable) combination thereof, and L¹ is Mn, Al, and/or a (e.g., any suitable) combination thereof.

For example, the positive electrode active material may be a high nickel-based positive electrode active material having a nickel content (e.g., amount) of about 80 mol % or more, about 85 mol % or more, about 90 mol % or more, about 91 mol % or more, or about 94 mol % or more, with respect to 100 mol % of metals excluding lithium from the lithium transition metal composite oxide. The high nickel-based positive electrode active material may achieve high capacity and thus be applied to high-capacity, high-density rechargeable lithium batteries.

### Negative Electrode 20

The negative electrode 20 for a rechargeable lithium battery may include a current collector COL2 and a negative electrode active material layer AML2 on the current collector COL2. The negative electrode active material layer AML2 may include a negative electrode active material, and may further include a binder and/or a conductive material (e.g., an electrically conductive material).

For example, the negative electrode active material layer AML2 may include about 90 wt % to about 99 wt % of the negative electrode active material, about 0.5 wt % to about 5 wt % of the binder, and about 0 wt % to about 5 wt % of the conductive material.

The binder may serve to attach (e.g., effectively attach) the negative electrode active material particles to each other and also to attach (e.g., effectively attach) the negative electrode active material to the current collector COL2. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, an ethylene propylene copolymer, polystyrene, polyurethane, polytetrafluoroethylene, polyvinylidene fluoride, polyethylene, polypropylene, poly amideimide, polyimide, and/or a (e.g., any suitable) combination thereof.

The aqueous binder may be selected from among a styrene-butadiene rubber, a (meth)acrylated styrene-butadiene rubber, a (meth)acrylonitrile-butadiene rubber, a (meth)acrylic rubber, a butyl rubber, a fluoro rubber, polyethylene oxide, polyvinyl pyrrolidone, polyepichlorohydrine, polyphosphazene, poly(meth)acrylonitrile, an ethylene propylene diene copolymer, polyvinylpyridine, chlorosulfonated polyethylene, latex, a polyester resin, a (meth)acrylic resin, a phenol resin, an epoxy resin, polyvinyl alcohol, and/or a (e.g., any suitable) combination thereof.

When an aqueous binder is used as the negative electrode binder, a cellulose-based compound capable of imparting viscosity may be further included. The cellulose-based compound may include at least one of carboxymethyl cellulose, hydroxypropyl methyl cellulose, methyl cellulose, or an alkali metal salt thereof. The alkali metal may include Na, K, or Li.

The dry binder may be a polymer material that is capable of being fibrous. For example, the dry binder may be polytetrafluoroethylene, polyvinylidene fluoride, a polyvinylidene fluoride-hexafluoropropylene copolymer, polyethylene oxide, and/or a (e.g., any suitable) combination thereof.

The conductive material may be used to impart conductivity to the electrode. Any material that does not cause chemical changes and is an electron conductive material may be usable in batteries. Examples of the conductive material may include a carbon-based material such as natural graphite, artificial graphite, carbon black, acetylene black, Ketjen black, carbon fiber, carbon nanofibers, and carbon nanotubes; a metal-based material including copper, nickel, aluminum, silver, and/or the like in a form of a metal powder or metal fibers; a conductive polymer such as a polyphenylene derivative; and/or a (e.g., any suitable) mixture thereof.

The current collector COL2 may include a copper foil, a nickel foil, a stainless steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that reversibly intercalates/deintercalates lithium ions, a lithium metal, a lithium metal alloy, a material capable of doping/de-doping lithium, or a transition metal oxide.

The material that reversibly intercalates/deintercalates lithium ions may include a carbon-based negative electrode active material, for example, crystalline carbon, amorphous carbon, and/or a (e.g., any suitable) combination thereof. Examples of the crystalline carbon may be graphite such as irregular, planar, flaky, spherical, or fibrous natural graphite or artificial graphite, and examples of the amorphous carbon may be soft carbon, hard carbon, mesophase pitch carbide, fired cokes, and/or the like.

The lithium metal alloy includes an alloy of lithium and a metal selected from among Na, K, Rb, Cs, Fr, Be, Mg, Ca, Sr, Si, Sb, Pb, In, Zn, Ba, Ra, Ge, Al, and Sn.

The material capable of doping/dedoping lithium may be a Si-based negative electrode active material or a Sn-based negative electrode active material. The Si-based negative electrode active material may be silicon, a silicon-carbon composite, SiOₓ (0<x≤2), a Si-Q alloy (where Q is selected from among an alkali metal, an alkaline earth metal, a Group 13 element, a Group 14 element (except for Si), a Group 15 element, a Group 16 element, a transition metal, a rare-earth element, and/or a (e.g., any suitable) combination thereof), and/or a (e.g., any suitable) combination thereof. The Sn-based negative electrode active material may be Sn, SnO₂, an Sn-based alloy, and/or a (e.g., any suitable) combination thereof.

The silicon-carbon composite may be a composite of silicon and amorphous carbon. According to one or more embodiments, the silicon-carbon composite may be in a form of silicon particles and amorphous carbon coated on the surface of the silicon particles. For example, the silicon-carbon composite may include a secondary particle (core), in which primary silicon particles are assembled, and an amorphous carbon coating layer (shell) on the surface of the secondary particle. The amorphous carbon may also be between the primary silicon particles, and, for example, the primary silicon particles may be coated with the amorphous carbon. The secondary particle may exist dispersed in an amorphous carbon matrix.

The silicon-carbon composite may further include crystalline carbon. For example, the silicon-carbon composite may include a core including crystalline carbon and silicon particles and an amorphous carbon coating layer on a surface of the core.

The Si-based negative electrode active material or the Sn-based negative electrode active material may be used in combination with a carbon-based negative electrode active material.

### Separator 30

Depending on the type (kind) of the rechargeable lithium battery, a separator 30 may be present between the positive electrode 10 and the negative electrode 20. The separator 30 may include polyethylene, polypropylene, polyvinylidene fluoride, a multilayer film of two or more layers thereof, and/or a mixed multilayer film such as a polyethylene/polypropylene two-layer separator, polyethylene/polypropylene/polyethylene three-layer separator, polypropylene/polyethylene/polypropylene three-layer separator, and/or the like.

The separator 30 may include a porous substrate and a coating layer including an organic material, an inorganic material, and/or a (e.g., any suitable) combination thereof on one or both surfaces (e.g., opposite surfaces) of the porous substrate.

The porous substrate may be a polymer film formed of any one polymer selected from among polyolefin such as polyethylene and polypropylene, polyester such as polyethylene terephthalate and polybutylene terephthalate, polyacetal, polyamide, polyimide, polycarbonate, polyether ketone, polyaryl ether ketone, polyetherimide, polyamideimide, polybenzimidazole, polyether sulfone, polyphenylene oxide, a cyclic olefin copolymer, polyphenylene sulfide, polyethylene naphthalate, glass fibers, polytetrafluoroethylene (e.g., TEFLON®), and/or a copolymer or mixture of two or more thereof.

The organic material may include a polyvinylidene fluoride-based polymer or a (meth)acrylic polymer.

The inorganic material may include inorganic particles selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, boehmite, and/or a (e.g., any suitable) combination thereof, but the present disclosure is not limited thereto.

The organic material and the inorganic material may be mixed in one coating layer, or a coating layer including an organic material and a coating layer including an inorganic material may be stacked.

### Electrolyte Solution ELL

The electrolyte solution ELL for a rechargeable lithium battery may include a non-aqueous organic solvent and a lithium salt.

The non-aqueous organic solvent may serve as a medium for transmitting ions taking part in the electrochemical reaction of a battery.

The non-aqueous organic solvent may be a carbonate-based, ester-based, ether-based, ketone-based, or alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methyl propyl carbonate (MPC), ethyl propyl carbonate (EPC), methyl ethyl carbonate (MEC), ethylene carbonate (EC), propylene carbonate (PC), butylene carbonate (BC), and/or the like.

The ester-based solvent may include methyl acetate, ethyl acetate, n-propyl acetate, dimethyl acetate, methyl propionate, ethyl propionate, decanolide, mevalonolactone, valerolactone, caprolactone, and/or the like.

The ether-based solvent may include dibutyl ether, tetraglyme, diglyme, dimethoxyethane, 2-methyltetrahydrofuran, 2,5-dimethyltetrahydrofuran, tetrahydrofuran, and/or the like. In one or more embodiments, the ketone-based solvent may include cyclohexanone, and/or the like. The alcohol-based solvent may include ethanol, isopropyl alcohol, and/or the like, and the aprotic solvent may include nitriles such as R-CN (where R is a C2 to C20 linear, branched, or cyclic hydrocarbon group and may include a double bond, an aromatic ring, or an ether group); amides such as dimethylformamide; dioxolanes such as 1,3-dioxolane, 1,4-dioxolane; sulfolanes, and/or the like.

The non-aqueous organic solvents may be used alone or in combination of two or more.

In one or more embodiments, if (e.g., when) using a carbonate-based solvent, a cyclic carbonate and a chain carbonate may be mixed and used, and the cyclic carbonate and the chain carbonate may be mixed in a volume ratio of about 1:1 to about 1:9.

The lithium salt dissolved in the organic solvent supplies lithium ions in a battery, enables the basic operation of the rechargeable lithium battery, and improves transportation of the lithium ions between positive and negative electrodes. Examples of the lithium salt include at least one selected from among LiPF₆, LiBF₄, LiSbF₆, LiAsF₆, LiClO₄, LiAlO₂, LiAlCl₄, LIPO₂F₂, LiCl, Lil, LiN(SO₃C₂F₅)₂, Li(FSO₂)₂N (lithium bis(fluorosulfonyl)imide, LiFSl), LiC₄F₉SO₃, LiN(CₓF₂ₓ₊₁SO₂) (C_{y}F_{2y+1}SO₂) (wherein x and y are integers of 1 to 20), lithium trifluoromethane sulfonate, lithium tetrafluoroethanesulfonate, lithium difluoro (oxalato) borate (LiDFOB), lithium difluorobis(oxalato)phosphate (LiDFBOP), and lithium bis(oxalato) borate (LiBOB).

### Rechargeable Lithium Battery

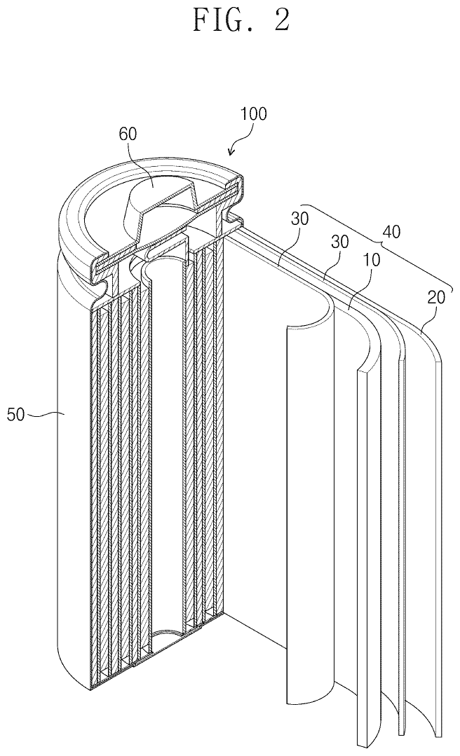

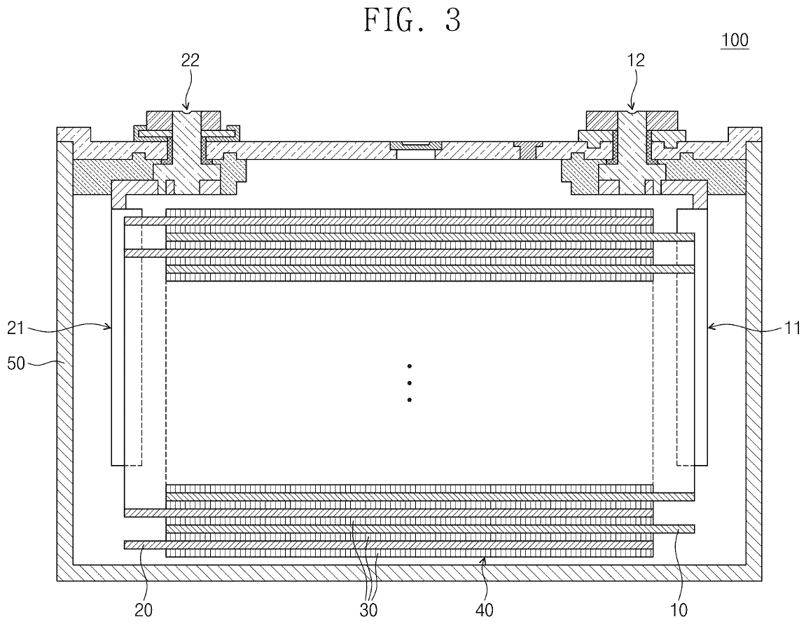

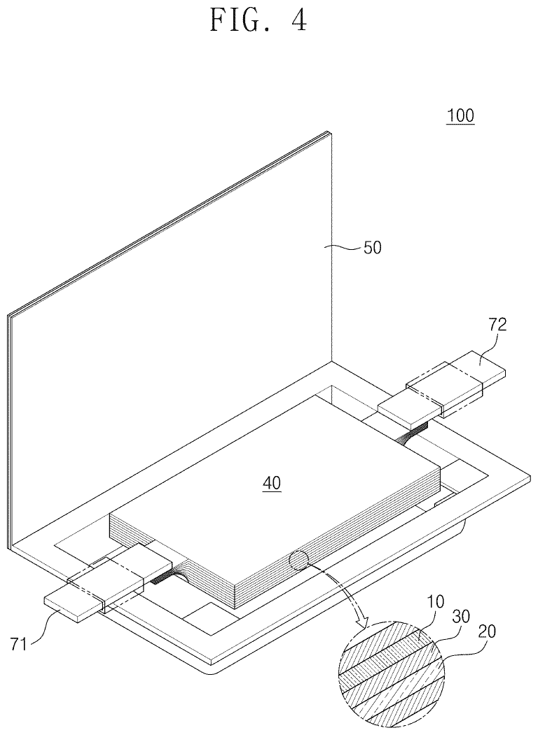

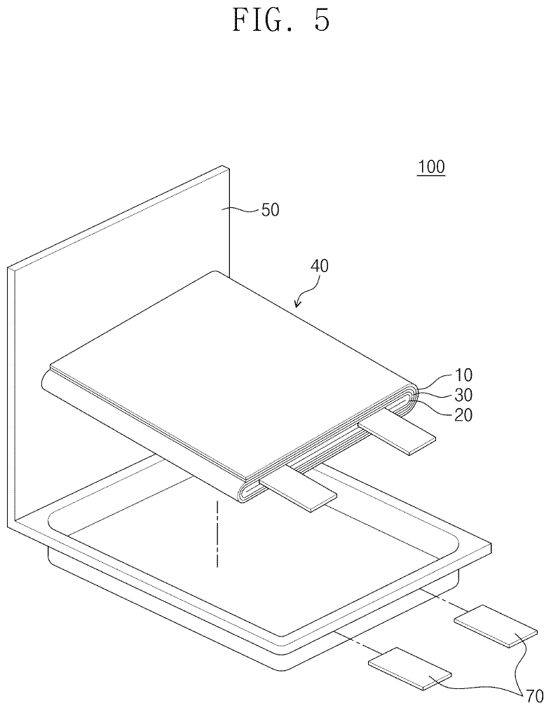

The rechargeable lithium battery may be classified into cylindrical, prismatic, pouch, or coin-type (kind) batteries, and/or the like depending on their shape. FIGS. 2 to 5 are schematic views each illustrating a rechargeable lithium battery according to one or more embodiments of the present disclosure. FIG. 2 shows a cylindrical battery, FIG. 3 shows a prismatic battery, and FIGS. 4 and 5 show pouch-type (kind) batteries. Referring to FIGS. 2 to 5, the rechargeable lithium battery 100 may include an electrode assembly 40 including a separator 30 between a positive electrode 10 and a negative electrode 20, and a case 50 in which the electrode assembly 40 is included. The positive electrode 10, the negative electrode 20, and the separator 30 may be impregnated with an electrolyte solution. The rechargeable lithium battery 100 may include a sealing member 60 sealing the case 50, as shown, for example, in FIG. 2. As shown, for example, in FIG. 3, the rechargeable lithium battery 100 may include a positive electrode lead tab 11, a positive electrode terminal 12, a negative electrode lead tab 21, and a negative electrode terminal 22. As shown, for example, in FIGS. 4 and 5, the rechargeable lithium battery 100 may include an electrode tab 70, which may be, for example, a positive electrode tab 71 and a negative electrode tab 72 serving as an electrical path for inducing the current formed in the electrode assembly 40 to the outside.

The rechargeable lithium battery according to one or more embodiments may be applied to automobiles, mobile phones, and/or one or more suitable types (kinds) of electric devices, as non-limiting examples.

Hereinafter, a negative electrode for a rechargeable lithium battery and a rechargeable lithium battery including the same according to one or more embodiments of the present disclosure will be described in more detail.

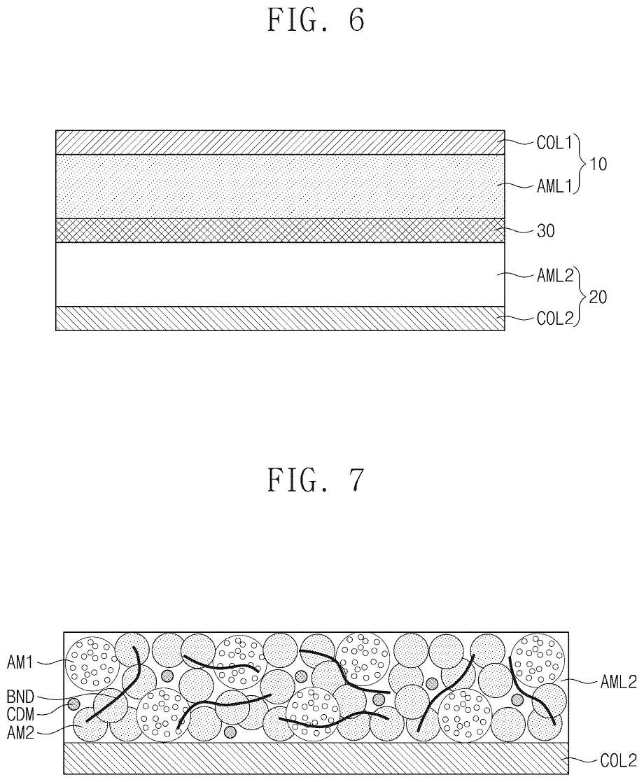

FIG. 6 is a cross-sectional view showing a rechargeable lithium battery according to one or more embodiments of the present disclosure.

Referring to FIG. 6, as described above with reference to FIG. 1, the rechargeable lithium battery according to one or more embodiments of the present disclosure may include a positive electrode 10, a negative electrode 20, and a separator 30 between the positive electrode 10 and the negative electrode 20. In one or more embodiments, the rechargeable lithium battery according to the present disclosure may further include an electrolyte solution ELL. The separator 30 may be impregnated with the electrolyte solution ELL.

The positive electrode 10 may include a positive electrode current collector COL1 and a positive electrode active material layer AML1 on the positive electrode current collector COL1. The negative electrode 20 may include a negative electrode current collector COL2 and a negative electrode active material layer AML2 on the negative electrode current collector COL2. The separator 30 may be interposed between the positive electrode active material layer AML1 and the negative electrode active material layer AML2.

### Negative Electrode Active Material Layer AML2

FIG. 7 is a cross-sectional view showing a negative electrode for a rechargeable lithium battery according to one or more embodiments of the present disclosure.

Referring to FIG. 7, the negative electrode active material layer AML2 according to one or more embodiments of the present disclosure may include a negative electrode active material. The negative electrode active material may include a first negative electrode active material AM1 and a second negative electrode active material AM2, which will be described in more detail later. The negative electrode active material layer may further include a binder BND and may further include a conductive material CDM.

The first negative electrode active material AM1 and the second negative electrode active material AM2 in the negative electrode active material layer AML2 may be provided in an amount in a range of about 90 wt % to about 98 wt % with respect to a total weight of the negative electrode active material layer AML2.

The first negative electrode active material AM1 may be provided in an amount in a range of about 5 wt % to about 50 wt % with respect to the total weight of the negative electrode active material layer AML2. For example, the first negative electrode active material AM1 may be provided in an amount in a range of about 5 wt % to about 15 wt %, about 10 wt % to about 25 wt %, about 20 wt % to about 35 wt %, or about 30 wt % to about 50 wt % with respect to the total weight of the negative electrode active material layer AML2.

The second negative electrode active material AM2 may be provided in an amount in a range of about 50 wt % to about 95 wt % with respect to the total weight of the negative electrode active material layer AML2. For example, the second negative electrode active material AM2 may be provided in an amount in a range of about 50 wt % to about 65 wt %, about 55 wt % to about 70 wt %, about 65 wt % to about 80 wt %, and about 70 wt % to about 95 wt % with respect to the total weight of the negative electrode active material layer AML2.

When the amounts of each of the first negative electrode active material AM1 and the second negative electrode active material AM2 satisfy the above ranges, a rechargeable lithium battery including the two may achieve high capacity and high energy density and exhibit enhanced (e.g., excellent or suitable) output characteristics and cycle life characteristics.

The binder BND may serve to attach (e.g., effectively attach) negative electrode active material particles to one another and also to attach (e.g., effectively attach) the negative electrode active material to a current collector. The binder BND may include, for example, at least one selected from the group consisting of polyvinyl alcohol, carboxymethyl cellulose, hydroxypropyl cellulose, diacetyl cellulose, polyvinyl chloride, carboxylated polyvinyl chloride, polyvinyl fluoride, an ethylene oxide-containing polymer, polyvinyl pyrrolidone, polyurethane, polytetrafluoroethylene, polyvinylidene fluoride, polyethylene, polypropylene, a styrene-butadiene rubber, a (meth)acrylated styrene-butadiene rubber, an epoxy resin, a (meth)acrylic resin, a polyester resin, and nylon, but the present disclosure is not limited thereto. The binder BND may be provided in an amount in a range of about 1 wt % to about 5 wt % with respect to the total weight of the negative electrode active material layer AML2. For example, the binder BND may be provided in an amount in a range of about 1 wt % to about 3 wt % or about 2 wt % to about 4 wt %, with respect to the total weight of the negative electrode active material layer AML2. When the amount of the binder BND satisfies the above ranges, excessive expansion during charge/discharge of a negative electrode including a high content (e.g., amount) of silicon may be prevented or reduced. In FIG. 7, the binder BND is shown as including fiber-like strands. However, the present disclosure is not limited thereto.

The conductive material CDM may be used to impart conductivity to the electrode (e.g., may be a conductor). Any material that does not cause chemical changes and is an electron conductive material may be usable in batteries. Examples of the conductive material CDM may include a carbon-based material, such as natural graphite, artificial graphite, carbon black, acetylene black, Ketjen black, and/or carbon fiber; a metal-based material metal fiber or metal powder, such as copper, nickel, aluminum, and/or silver; a conductive polymer, such as a polyphenylene derivative; and/or a (e.g., any suitable) mixture thereof. The shapes of the binder BND and conductive material CDM shown in FIG. 7 are schematic representations provided to facilitate understanding, and the present disclosure is not necessarily limited thereto.

In one or more embodiments, carbon nanotubes, carbon fiber, carbon nanofibers, and/or a (e.g., any suitable) combination thereof may be used as the conductive material CDM. The carbon nanotubes may be a single-walled carbon nanotubes (SWCNT), double-walled carbon nanotubes (DWCNT), multi-walled carbon nanotubes (MWCNT), and/or a (e.g., any suitable) combination thereof.

The conductive material CDM may be provided in an amount in a range of about 1 wt % to about 5 wt % with respect to the total weight of the negative electrode active material layer AML2. For example, the conductive material CDM may be provided in an amount in a range of about 1 wt % to about 2 wt %, about 1 wt % to about 3 wt %, about 2 wt % to about 3.5 wt %, or about 2 wt % to about 4 wt % with respect to the total weight of the negative electrode active material layer AML2. When the amount of the conductive material CDM satisfies the above ranges, a contact area between negative electrode active material particles may be sufficiently secured. This may improve the electrical conductivity of an electrode plate and extend the lifespan of batteries.

### First Negative Electrode Active Material AM1

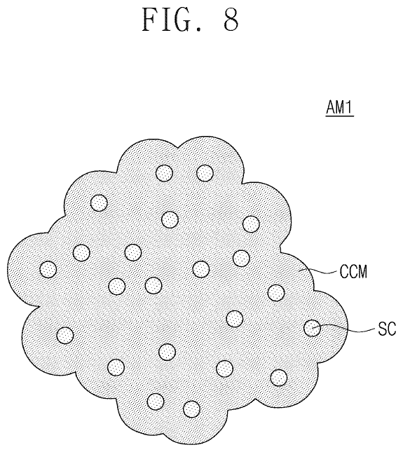

FIG. 8 is a view schematically showing a first negative electrode active material according to one or more embodiments of the present disclosure.

Referring to FIG. 8, the first negative electrode active material AM1 may include a matrix CCM containing a first crystalline carbon, and silicon SC dispersed in the matrix CCM.

The first negative electrode active material AM1 may have a specific surface area according to the Brunauer, Emmett and Teller (BET) method (hereinafter, “the BET specific surface area”) of about 8 m²/g or less. For example, the first negative electrode active material AM1 may have a BET specific surface area in a range of about 0.5 m²/g to about 8 m²/g, about 1 m²/g to about 6 m²/g, or about 3 m²/g to about 6 m²/g. When the BET specific surface area of the first negative electrode active material AM1 satisfies the above ranges, a reaction area with an electrolyte solution may be minimized or reduced, and thus the probability of an irreversible reaction is reduced during charge/discharge, resulting in enhanced cycle life characteristics.

Herein, the term “BET specific surface area” may be a specific surface area obtained by measuring the amount of gas adsorbed onto a material's surface at a specific temperature to provide an adsorption isotherm, according to Brunauer, Emmett and Teller (BET) method. Nitrogen gas may be used as an adsorption gas for measuring the adsorption isotherm.

The first negative electrode active material AM1 may have a graphitization degree of about 95% or more. For example, the first negative electrode active material AM1 may have a graphitization degree in a range of about 95% to about 97%, about 96% to about 98%, or about 97% to about 99%.

Herein, the term “graphitization degree” indicates a ratio of a layered structure included in a carbon-containing material. A high graphitization degree indicates that the carbon-containing material contains a large amount of layered structure (e.g., indicates that the carbon material resembles graphite, a highly ordered crystalline form of carbon). The graphitization degree may be obtained through X-ray diffraction measurement. For example, d002 may be measured in accordance with JIS K 0131-1996 or JB/T 4220-2011 using an X-ray diffraction analyzer (e.g., Bruker D8 Discover), and then calculated using (0.344-d002)/(0.344-0.3354)×100% to obtain a graphitization degree. Herein, d002 is an interlayer spacing of a graphite crystal structure indicated in nanometers (nm). The X-ray diffraction measurement may be performed using CuKα rays as a target line, for example, with a wavelength of λ±0.02 Å (angstroms), a scanning range of about 20 20° to 80°, and a scan speed of about 1°/min to about 5°/min.

The matrix CCM may include first crystalline carbon. The first crystalline carbon may be amorphous, plate-shaped, flaky, spherical, or fibrous artificial graphite.

The matrix CCM may be porous. The matrix CCM, if (e.g., when) porous, may be to absorb the volume expansion of silicon SC, which may take place during charge/discharge. Accordingly, an increase in overall volume of the first negative electrode active material AM1 may be reduced or prevented.

For example, the matrix CCM includes pores, and thus the pores may serve as a buffer that absorbs the volume expansion, and accordingly, the volume expansion of silicon SC dispersed in the matrix CCM may be absorbed or substantially absorbed. Consequently, the first negative electrode active material AM1 may help maintain the structure of itself and the negative electrode active material layer AML2 during charge/discharge, resulting in improved cycle life characteristics, and higher efficiency and charge rate.

In one or more embodiments, the matrix CCM may have a porosity in a range of about 1% to about 50%, about 1% to about 30%, or about 1% to about 10%. When the porosity of the matrix CCM satisfies the above ranges, the volume expansion of silicon SC may be absorbed more effectively, thereby further improving cycle life characteristics.

The porosity may be measured through a general porosity measurement method. For example, the porosity may be measured through mercury intrusion porosimetry. Alternatively, in one or more embodiments, the porosity may be measured using the method of Barret-Joyner-Halenda (BJH) to provide a N₂ absorption isotherm. For example, the matrix CCM may be heated to about 523 K (Kelvin, absolute temperature) at a rate of about 10 K/min and then pretreated at this temperature and a pressure of about 100 mmHg or less for about 2 hours to about 10 hours, and then nitrogen may be adsorbed at about 32 points from a relative pressure of about 0.01 torr to about 0.955 torr in liquid nitrogen adjusted to a relative pressure (P/P0) of about 0.01 torr or less, and then desorbed at about 24 points up to a relative pressure of about 0.14 tors to measure the porosity. For the matrix CCM volume, the porosity may be obtained from the N₂ content (e.g., amount) measured through the method described above.

The silicon SC may fill the pores of the matrix CCM. The silicon SC may be dispersed in the matrix CCM. For example, the silicon SC may be dispersed inside the matrix CCM and thus not exposed to the outside, and accordingly, side reactions caused by contact between the silicon SC and an electrolyte solution may be reduced or suppressed. In one or more embodiments, as described above, if (e.g., when) the silicon SC expands during charge/discharge, the matrix CCM may buffer the expansion and thus reduce or suppress the volume expansion of batteries. Accordingly, the high-capacity characteristics of the silicon SC may be effectively utilized. For example, because the matrix CCM is capable of buffering the volume expansion of the batteries, high-capacity batteries using this negative electrode active material may be created without the batteries failing or having decreased cycle life characteristics due to the increased pressure caused by the volume expansion.

The silicon SC may be nano silicon. For example, the silicon SC may be particle type (kind) nano silicon. The nano silicon may have an average size (e.g., average diameter) in a range of about 50 nm or less. For example, the nano silicon may have an average size in a range of about 1 nm to about 50 nm, about 1 nm to about 30 nm, about 1 nm to about 20 nm, or about 2 nm to about 15 nm. The silicon SC, as the above-sized nano silicon, may have less volume expansion during charge/discharge of a lithium ion battery, benefiting cycle life characteristics. The average size of the silicon SC may be an average particle diameter if (e.g., when) the silicon is a spherical particle. If (e.g., when) the silicon SC is a non-spherical particle, for example, a plate-shaped particle or an acicular particle, the average size may indicate an average major axis length.

The silicon SC may be provided in an amount in a range of about 1 wt % to about 55 wt %, about 5 wt % to about 55 wt %, about 10 wt % to about 55 wt %, or about 27 wt % to about 55 wt % with respect to a total weight of the first negative electrode active material AM1. When the amount of the silicon SC satisfies the above ranges, a rechargeable lithium battery exhibiting enhanced (e.g., excellent or suitable) capacity and energy density may be provided.

In one or more embodiments, the silicon SC may be pure silicon. However, silicon may be naturally oxidized and present in a trace amount in the negative electrode active material in the form of silicon oxide.

According to one or more embodiments, the first negative electrode active material AM1 may further contain a trace amount of oxygen. The amount of oxygen may be provided in an amount in a range of about 0.5 wt % to about 20 wt %, about 0.5 wt % to about 10 wt %, or about 0.5 wt % to about 1 wt % with respect to the total weight of the first negative electrode active material AM1. When the oxygen is provided in a trace amount within the above ranges, initial efficiency is high, and thus higher battery efficiency may be achieved, irreversible capacity may be significantly reduced, and side reactions may be further reduced, thereby further improving cycle life characteristics.

In this specification, the amount of oxygen may be measured through infrared absorption using an oxygen analyzer. Measurement conditions may be appropriately or suitably adjusted within suitable conditions available and/or generally utilized in the art.

The first negative electrode active material AM1 may have a crystallite size Lc (100) of about 3500 nm to about 4000 nm in a c-axis direction and a crystallite size La (002) of about 2500 nm to about 3000 nm in an a-axis direction, as determined by X-ray diffraction (XRD) analysis. The Lc and La may be determined through X-ray diffraction (wavelength: about 1.54 Å) analysis using Cu-Kα line as a target line.

The first negative electrode active material AM1 may have a pellet density of about 1.75 g/cc or more. For example, the first negative electrode active material AM1 may have a pellet density of about 1.75 g/cc to about 1.9 g/cc, or about 1.8 g/cc to about 2.0 g/cc.

The first negative electrode active material AM1 may have an average particle diameter (D50) in a range of about 10 μm to about 20 μm. For example, the first negative electrode active material AM1 may have an average particle diameter (D50) in a range of about 12 μm to about 15 μm, about 14 μm to about 17 μm, or about 16 μm to about 19 μm. When the average particle diameter of the first negative electrode active material AM1 satisfies the above ranges, a negative electrode formed from a negative electrode active material including the first negative electrode active material AM1 may have greater mixture density, and thus a battery employing the negative electrode may have increased capacity and improved cycle life characteristics.

In this specification, the average particle diameter (D50) may be measured using a particle size analyzer. The average particle diameter may indicate a particle diameter if (e.g., when) a cumulative volume is about 50 vol % in particle size distribution.

### Second Negative Electrode Active Material AM2

The second negative electrode active material AM2 according to one or more embodiments of the present disclosure may include second crystalline carbon.

The second crystalline carbon may be single particle artificial graphite (e.g., may include artificial graphite that is made of separate, individual particles). In one or more embodiments, the second crystalline may be amorphous, plate-shaped, flaky, spherical, or fibrous artificial graphite.

The second crystalline carbon may further include a coating layer. The coating layer may be formed on at least a portion of a surface of the second crystalline carbon particles (e.g., a portion of a surface of each of the second crystalline carbon particles). The surfaces of second crystalline carbon particles may be entirely or partially surrounded by the coating layer. For example, the second negative electrode active material AM2 may have a core-shell structure including the second crystalline carbon (core) and the coating layer (shell).

The coating layer may include amorphous carbon. The amorphous carbon may include soft carbon, hard carbon, mesophase pitch carbide, fired coke, and/or a (e.g., any suitable) combination thereof.

The amorphous carbon may be provided in an amount in a range of about 0.1 wt % to about 3 wt % with respect to the total weight of the second negative electrode active material AM2. For example, the amorphous carbon may be provided in an amount in a range of about 0.5 wt % to 1 wt % or 1 wt % to 2 wt % with respect to the total weight of the second negative electrode active material AM2. When the amorphous carbon is provided in an amount satisfying the above ranges, improved cycle life characteristics and rate characteristics may be achieved along with high capacity.

The coating layer may have a thickness in a range of about 1 nm to about 1 μm. For example, the coating layer may have a thickness in a range of about 1 nm to about 500 nm, about 10 nm to about 300 nm, or about 20 nm to about 200 nm. When the thickness of the coating layer satisfies the above ranges, degradation in rate characteristics and cycle life characteristics of batteries may be reduced or prevented. When the thickness of the coating layer is greater than about 1 μm, the coating layer serves as a resistance layer when lithium is absorbed and desorbed during charge/discharge, leading to degradation in capacity and efficiency.

For example, the second negative electrode active material AM2, if (e.g., when) further including a coating layer, may protect the surface of second crystalline carbon particles, thereby reducing or preventing cracks within the particles due to charge/discharge, and may help the second negative electrode active material AM2 remain in substantially the same in shape (e.g., may help the second negative electrode active material AM2 maintain its shape). In one or more embodiments, side reactions with an electrolyte solution on the surface of second crystalline carbon particles may be reduced or minimized, resulting in improved cycle life characteristics and rate characteristics of batteries including the second negative electrode active material AM2.

The second negative electrode active material AM2 may have a graphitization degree in a range of about 88% to about 94%. For example, the second negative electrode active material AM2 may have a graphitization degree in a range of about 89% to about 91%, about 90% to about 92%, or about 91% to about 93%.

According to one or more embodiments, the second negative electrode active material AM2 may have a lower graphitization degree than the first negative electrode active material AM1 described above. Therefore, a combination of different negative electrode active materials each having different graphitization degrees may allow improved cycle life characteristics and rate characteristics along with high capacity and high energy.

The second negative electrode active material AM2 may have a crystallite size Lc (100) in a range of about 800 nm to about 2000 nm in a c-axis direction and a crystallite size La (002) in a range of about 1500 nm to about 1800 nm in an a-axis direction, as determined by X-ray diffraction (XRD) analysis.

The second negative electrode active material AM2 may have a pellet density of about 1.5 g/cc or more. For example, the second negative electrode active material AM2 may have a pellet density in a range of about 1.3 g/cc to about 1.5 g/cc, or about 1.2 g/cc to about 1.4 g/cc.

The second negative electrode active material AM2 (e.g., the second crystalline carbon particles of the second negative electrode active material AM2 including the coating layer) may have an average particle diameter (D50) of about 10 μm or less. For example, the second negative electrode active material AM2 may have an average particle diameter (D50) in a range of about 6 μm to about 9 μm or about 6 μm to about 8 μm. When the average particle diameter of the second negative electrode active material AM2 satisfies the above ranges, lithium ions may be readily inserted, thereby improving battery resistance and rate characteristics and increasing the tap density of a final negative electrode active material, resulting in improved electrode processability. Herein, “tap density” refers to the mass per unit volume of a material after it has been mechanically tapped or vibrated to reduce or remove the voids or air gaps between particles.

In one or more embodiments, the average particle diameter of the second negative electrode active material AM2 may be smaller than the average particle diameter of the first negative electrode active material AM1 described above. For example, the second negative electrode active material AM2 may substantially fill spaces between the particles of the first negative electrode active material AM1 having a relatively large average particle diameter, thereby reducing or minimizing voids inside an electrode plate and providing a dense negative electrode.

The first negative electrode active material AM1 and the second negative electrode active material AM2 may be included in a weight ratio in a range of about 10:90 to about 50:50. For example, the first and second negative electrode active materials AM1 and AM2 may be provided in a weight ratio in a range of about 10:90 to about 40:60 or about 20:80 to about 40:60. When the weight ratio of the first and second negative electrode active materials AM1 and AM2 satisfies the above ranges, high capacity and high energy density may be achieved along with improved charge/discharge cycle life characteristics and rate characteristics.

A negative electrode active material including both the first and second negative electrode active materials AM1 and AM2 may have a tap density in a range of about 1.0 g/cc to about 1.2 g/cc. When the tap density of the negative electrode active material satisfies the above range, the internal pores of the negative electrode active material layer AML2 are reduced and side reactions with an electrolyte solution are reduced, thereby improving cycle life characteristics.

The negative electrode active materials AM1 and AM2 may have a pellet density in a range of about 1.3 g/cc to about 1.6 g/cc. According to the pellet density value, it is seen that the negative electrode active material has high density characteristics and thus exhibits enhanced (e.g., excellent or suitable) rollability. Accordingly, a negative electrode obtained from the negative electrode active material may have high capacity and a high energy density.

The negative electrode active material layer AML2 including the first and second negative electrode active materials AM1 and AM2 may have a porosity in a range of about 20% to about 40%. For example, the negative electrode active material layer AML2 may have a porosity of about 20% to about 35% or about 25% to about 40%. When the porosity of the negative electrode active material layer AML2 satisfies the above ranges, the negative electrode active material layer AML2 may remain dense enough so that it may be sufficiently impregnated with an electrolyte solution with no excess of an area where the negative electrode active material layer AML2 reacts with the electrolyte solution, resulting in appropriate or suitable cycle life characteristics and rate characteristics.

The negative electrode for a rechargeable lithium battery according to one or more embodiments of the present disclosure may achieve both (e.g., simultaneously) the benefit of the first negative electrode active material having high capacity and high energy density and the benefit of the second negative electrode active material having enhanced (e.g., excellent or suitable) life and output characteristics. For example, according to one or more embodiments of the present disclosure, combining and using different types (kinds) of negative electrode active materials (e.g., the first and second negative electrode active materials) each having different properties may provide high capacity and high energy density and effectively improve rate characteristics, cycle life characteristics, and electrode plate processability.

Hereinafter, Examples and Comparative Examples of the present disclosure will be described. However, the following Examples are presented only as one or more embodiments of the present disclosure, and the present disclosure is not limited by the following Examples.

### Example 1

### Preparation of First Negative Electrode Active Material

Lignin and Fe (average size (D50): 100 nm) were mixed in a weight ratio of 80:20 to prepare a mixture.

The mixture was heat-treated at 1500° C. in a nitrogen atmosphere to prepare a heat-treated product containing Fe and artificial graphite.

The heat-treated product was immersed in hydrochloric acid to prepare a porous artificial graphite matrix from which the Fe was removed. The porous graphite matrix had a BET (Brunauer, Emmet, Teller) specific surface area of 6 m²/g obtained from the adsorption isotherm using the BET (Brunauer, Emmet, Teller) method. In addition, the porous graphite matrix had a graphitization degree of 95%, as determined by an X-ray diffraction analyzer (Bruker D8 Discover).

Silicon was supported in the porous artificial graphite matrix using chemical vapor deposition (CVD). Accordingly, a first negative electrode active material, in which silicon was dispersed in the porous artificial graphite matrix, was prepared. The first negative electrode active material had silicon in an amount of 30 wt % with respect to a total weight of the first negative electrode active material.

### Preparation of Second Negative Electrode Active Material

Ordinary coke was heat-treated in a furnace at 3,000° C. for 52 hours in a nitrogen atmosphere to prepare single-particle artificial graphite. The single-particle artificial graphite (e.g., artificial graphite composed of separate, individual particles of artificial graphite) and 3.33 g of liquid coal-based pitch (solid content (e.g., amount): 60 wt %, carbonization yield: 2 wt %) as an amorphous carbon precursor were mixed using a mixer at 300° C. Consequently, a second negative electrode active material, in which the single-particle artificial graphite was coated with amorphous carbon, was prepared. The second negative electrode active material had a graphitization degree of 90%.

### Preparation of Negative Electrode

10 wt % of the first negative electrode active material and 90 wt % of the second negative electrode active material were mixed to prepare a negative electrode active material.

96.3 wt % of the prepared negative electrode active material, 1.5 wt % of styrene butadiene rubber (SBR), 1.2 wt % of carboxymethyl cellulose, and 1 wt % of a carbon nanotube dispersion as a conductive material were mixed in a water solvent to prepare a negative electrode slurry.

The negative electrode slurry was applied onto a Cu foil current collector, and then dried and roll pressed to prepare a negative electrode.

### Preparation of Half Cell

A half cell was prepared using the negative electrode, a lithium metal counter electrode, and an electrolyte solution. The electrolyte solution used was a mixed solvent of ethylene carbonate and dimethyl carbonate (volume ratio: 3:7) in which 1 M LiPF₆ was dissolved.

### Example 2

A negative electrode and a half cell were prepared in substantially the same manner as in Example 1, except that a negative electrode active material in which 20 wt % of the first negative electrode active material and 80 wt % of the second negative electrode active material were mixed was used.

### Example 3

A negative electrode and a half cell were prepared in substantially the same manner as in Example 1, except that a negative electrode active material in which 30 wt % of the first negative electrode active material and 70 wt % of the second negative electrode active material were mixed was used.

### Example 4

A negative electrode and a half cell were prepared in substantially the same manner as in Example 1, except that a negative electrode active material in which 40 wt % of the first negative electrode active material and 60 wt % of the second negative electrode active material were mixed was used.

### Example 5

A negative electrode and a half cell were prepared in substantially the same manner as in Example 1, except that a negative electrode active material in which 50 wt % of the first negative electrode active material and 50 wt % of the second negative electrode active material were mixed was used.

### Comparative Example 1

A negative electrode and a half cell were prepared in substantially the same manner as in Example 1, except that 100 wt % of the first negative electrode active material was used as a negative electrode active material.

### Comparative Example 2

A negative electrode and a half cell were prepared in substantially the same manner as in Example 1, except that 100 wt % of the second negative electrode active material was used as a negative electrode active material.

### Evaluation Example 1: Measurement of Tap Density and Pellet Density of Negative Electrode Active Material

The tap density and pellet density of the negative electrode active materials prepared according to Examples 1 to 5 and Comparative Examples 1 and 2 were measured. The results are shown in Table 1.

1) Tap density: a 100 cc measuring cylinder was filled with a 50 cc negative electrode active material sample, and then the sample was subjected to 500 cycles of tapping back and forth at 3 mm per second, and the tap density was measured by dividing the mass by the volume.

2) Pellet density: 1 g of the negative electrode active material sample was placed in a mold, kept for 30 seconds under a pressure of 2 tons, and the pellet density was measured by checking changes in thickness of the prepared pellet.

### Evaluation Example 2: Measurement of Porosity of Negative Electrode

For the negative electrodes for rechargeable lithium batteries according to Examples 1 to 5 and Comparative Examples 1 and 2, the porosity of the negative electrode active material layer was measured using scanning electron microscopy (SEM), and the results are shown in Table 1. The SEM device used for measuring the porosity was a Magellan (FEI company), and the analysis conditions were as follows: 3 keV, 0.8 nA BSE and 5 keV, 3.2 nA EDS.

TABLE 1

| | Weight ratio of 1st and | Pellet | Tap | |
|---|---|---|---|---|
| | 2nd negative electrode | density | density | Porosity |
| | active materials | (g/cc) | (g/cc) | (%) |
| Example 1 | 10:90 | 1.33 | 1.05 | 27 |
| Example 2 | 20:80 | 1.38 | 1.06 | 30 |
| Example 3 | 30:70 | 1.44 | 1.08 | 32 |
| Example 4 | 40:60 | 1.50 | 1.10 | 37 |
| Example 5 | 50:50 | 1.56 | 1.10 | 35 |
| Comparative | 100:0 | 1.70 | 1.13 | 42 |
| Example 1 | | | | |
| Comparative | 0:100 | 1.32 | 1.05 | 25 |
| Example 2 | | | | |

Referring to Table 1, the negative electrode active materials according to Examples 1 to 5 have pellet densities in a range of 1.3 g/cc to 1.6 g/cc and tap densities in a range of 1.0 g/cc to 1.2 g/cc. In addition, the negative electrodes according to Examples 1 to 5 have porosities in a range of 20% to 40%.

### Evaluation Example 3: Measurement of Specific Capacity and Energy Density

The half cells prepared according to Examples 1 to 5 and Comparative Examples 1 and 2 were charged at 0.2 C to measure charging capacity. The results are shown in Table 2 as specific capacity (mAh/g) and energy density (mAh/cc).

### Evaluation Example 4: Evaluation of Rate Characteristic

The half cells manufactured according to Examples 1 to 5 and Comparative Examples 1 and 2 were first charged and discharged at 0.1 C (1st cycle), and then were charged and discharged at 0.2 C (2^{nd} cycle) to measure charging capacity at 0.2 C. Thereafter, the half cells were charged at 2.0 C with a 0.01 V cut-off, charged at a constant voltage condition with a 0.01 C cut-off, and discharged at 0.2 C at a constant current condition with a 1.5 V cut-off to measure charging capacity at 2 C. The charging capacity at 2 C and the charging capacity at 0.2 C were obtained to evaluate rate characteristics. The results are shown in Table 2.

### Evaluation Example 5: Evaluation of Cycle Life Characteristics

The half cells prepared according to Examples 1 to 5 and Comparative Examples 1 and 2 were subjected to 300 cycles of charge/discharge at 0.5 C rate. Life characteristics were evaluated by calculating a ratio of discharge capacity after 300 cycles to discharge capacity after the first cycle. The results are shown in Table 2 as capacity retention.

TABLE 2

| | | Energy density | | |
|---|---|---|---|---|
| | | (mAh/cc, based | | |
| | Specific | on mixture | Rate | Capacity |
| | capacity | density 1.65 | characteristics | retention |
| | (mAh/g) | g/cc) | (%) | (%) |
| Example 1 | 400 | 660 | 39.2 | 85.4 |
| Example 2 | 470 | 775 | 40.4 | 83.2 |
| Example 3 | 539 | 890 | 36.9 | 80.5 |
| Example 4 | 609 | 1005 | 38.8 | 80.8 |
| Example 5 | 679 | 1120 | 32.7 | 78.7 |
| Comparative | 364 | 630 | 28.8 | 58.6 |
| Example 1 | | | | |
| Comparative | 298 | 570 | 31.4 | 67.9 |
| Example 2 | | | | |

Referring to Table 2, the batteries according to Examples 1 to 5 have high capacity and high energy density along with enhanced (e.g., excellent or suitable) capacity retention and high rate characteristics, compared to the batteries according to Comparative Examples 1 and 2.

Accordingly, the rechargeable lithium battery according to embodiments of the present disclosure have high capacity and high energy density along with enhanced (e.g., excellent or suitable) life and rate characteristics. For example, when the weight ratios of the first and second negative electrode active materials satisfy the ranges described above, rechargeable lithium batteries having high capacities and high energy densities along with enhanced (e.g., excellent or suitable) life and rate characteristics may be provided.

Consequently, mixing different types (kinds) of negative electrode active materials each having different graphitization degrees, pellet densities, and/or the like at a specific ratio may enable a rechargeable lithium battery to have high energy density and improved life and high rate characteristics due to synergy effects from the combination of these materials. For instance, the first negative electrode active material, which includes silicon dispersed in a porous artificial graphite matrix, contributes to high capacity and energy density. On the other hand, the second negative electrode active material, which is composed of single-particle artificial graphite coated with amorphous carbon, enhances the electrode's structural stability and processability. By designing or configuring the weight ratios of these two materials, as demonstrated in Examples 1 to 5, the resulting negative electrodes exhibit a balance of high capacity, energy density, and excellent cycle life and rate characteristics. This is evidenced by the specific capacity, energy density, rate characteristics, and capacity retention data presented in Table 2.

According to embodiments of the present disclosure, a negative electrode for a rechargeable lithium battery exhibiting high capacity, long life, and high input/output characteristics and a rechargeable lithium battery including the same may be provided. The examples illustrate that by adjusting the proportions of the first and second negative electrode active materials, it is possible to tailor the performance characteristics of the battery to meet specific application requirements. This approach leverages the complementary properties of the different active materials to enhance overall battery performance, making it suitable for various suitable applications.

Unless otherwise defined, all terms (including technical and scientific terms) used herein have the same meaning as commonly understood by one of ordinary skill in the art to which the present disclosure belongs. It will be further understood that terms, such as those defined in commonly used dictionaries, should be interpreted as having a meaning that is consistent with their meaning in the context of the relevant art and/or the present specification, and should not be interpreted in an idealized or overly formal sense, unless expressly so defined herein.

Further, the use of “may” when describing embodiments of the present disclosure refers to “one or more embodiments of the present disclosure.”

As used herein, the term “substantially,” “about,” and similar terms are used as terms of approximation and not as terms of degree, and are intended to account for the inherent deviations in measured or calculated values that would be recognized by those of ordinary skill in the art. Unless otherwise defined, “substantially” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “substantially” may mean within one or more standard deviations, or within +30%, 20%, 10%, 5% of the stated value.

Also, any numerical range disclosed and/or recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

The negative electrode, the electrode assembly, the electronic device, the vehicle, the battery (e.g., a battery controller), a manufacturing device thereof, and/or any other relevant devices or components according to embodiments of the present disclosure described herein may be implemented utilizing any suitable hardware, firmware (e.g., an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

A person of ordinary skill in the art, in view of the present disclosure in its entirety, would appreciate that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

It will be understood that descriptions of features or aspects within each embodiment should typically be considered as available for other similar features or aspects in other embodiments, unless otherwise described. Thus, as would be apparent to one of ordinary skill in the art, features, characteristics, and/or elements described in connection with a particular embodiment may be used singly or in combination with features, characteristics, and/or elements described in connection with other embodiments unless otherwise specifically indicated. It is to be understood that the foregoing is an illustration of various example embodiments and is not to be construed as limited to the specific embodiments disclosed herein, and that various modifications to the disclosed embodiments, as well as other example embodiments, are intended to be included within the spirit and scope of the present disclosure as defined in the appended claims, and their equivalents.

What is claimed is:

1. A negative electrode comprising:
a negative electrode current collector; and
a negative electrode active material layer on the negative electrode current collector,
wherein the negative electrode active material layer comprises a negative electrode active material, the negative electrode active material comprising:
a first negative electrode active material comprising a matrix comprising a first crystalline carbon and silicon dispersed in the matrix; and
a second negative electrode active material comprising a second crystalline carbon,
wherein the second negative electrode active material has a graphitization degree in a range of about 88% to about 94%, and
wherein the negative electrode is for a rechargeable battery.

2. The negative electrode of claim 1, wherein the matrix has a BET specific surface area of about 8 m²/g or less and a graphitization degree of about 95% or more.

3. The negative electrode of claim 1, wherein the silicon is nano silicon, and the nano silicon has an average size in a range of about 1 nm to about 50 nm.

4. The negative electrode of claim 1, wherein the second crystalline carbon comprises single particle artificial graphite.

5. The negative electrode of claim 4, wherein the second crystalline carbon comprises a coating layer and the coating layer comprises amorphous carbon.

6. The negative electrode of claim 1, wherein the first negative electrode active material has a crystallite size Lc (100) in a range of about 3500 nm to about 4000 nm in a c-axis direction and a crystallite size La (002) in a range of about 2500 nm to about 3000 nm in an a-axis direction, as determined by X-ray diffraction (XRD) analysis.

7. The negative electrode of claim 1, wherein the second negative electrode active material has a crystallite size Lc (100) in a range of about 800 nm to about 2000 nm in a c-axis direction and a crystallite size La (002) in a range of about 1500 nm to about 1800 nm in an a-axis direction, as determined by X-ray diffraction (XRD) analysis.

8. The negative electrode of claim 1, wherein:
the first negative electrode active material has a pellet density of about 1.75 g/cc or more; and
the second negative electrode active material has a pellet density of about 1.5 g/cc or less.

9. The negative electrode of claim 1, wherein:
the first negative electrode active material has an average particle diameter (D50) in a range of about 10 μm to about 20 μm; and
the second negative electrode active material has an average particle diameter (D50) in a range of about 10 μm or less.

10. The negative electrode of claim 1, wherein the first negative electrode active material and the second negative electrode active material are provided in a weight ratio in a range of about 10:90 to about 50:50.

11. The negative electrode of claim 1, wherein the negative electrode active material has a tap density in a range of about 1.0 g/cc to about 1.2 g/cc.

12. The negative electrode of claim 1, wherein the negative electrode active material has a porosity in a range of about 20% to about 40%.

13. The negative electrode of claim 1, wherein the negative electrode active material further comprises a binder and/or a conductive material.

14. A negative electrode comprising:
a negative electrode current collector; and
a negative electrode active material layer on the negative electrode current collector,
wherein the negative electrode active material layer comprises a negative electrode active material, the negative electrode active material comprising:
a first negative electrode active material comprising a matrix comprising a first crystalline carbon and silicon dispersed in the matrix; and
a second negative electrode active material comprising a second crystalline carbon,
wherein the first negative electrode active material and the second negative electrode active material are provided in a weight ratio in a range of about 10:90 to about 50:50, and
wherein the negative electrode is for a rechargeable battery.

15. The negative electrode of claim 14, wherein the matrix has a BET specific surface area of about 8 m²/g or less and a graphitization degree of about 95% or more.

16. The negative electrode of claim 14, wherein the silicon is nano silicon and the nano silicon has an average size in a range of about 1 nm to about 50 nm.

17. The negative electrode of claim 14, wherein the second crystalline carbon is single particle artificial graphite and the single particle artificial graphite comprises an amorphous carbon coating layer.

18. The negative electrode of claim 14, wherein the second negative electrode active material has a graphitization degree in a range of about 88% to about 94%.

19. The negative electrode of claim 14, wherein the negative electrode active material has a tap density in a range of about 1.0 g/cc to about 1.2 g/cc.

20. A rechargeable lithium battery comprising:
the negative electrode of claim 1;
a positive electrode; and
a separator between the negative electrode and the positive electrode.
